(19) United States
(12) Patent Application Publication
(10) Pub. No.: US 2015/0010698 A1
(43) Pub. Date: Jan. 8, 2015

(54) METHOD OF MANUFACTURING HEXAGONAL FERRITE MAGNETIC PARTICLES

(71) Applicant: FUJIFILM CORPORATION, Tokyo (JP)

(72) Inventors: Yasushi HATTORI, Minami-ashigara-shi (JP); Yoshinori TAMADA, Minami-ashigara-shi (JP)

(73) Assignee: FUJIFILM CORPORATION, Tokyo (JP)

(21) Appl. No.: 14/324,852

(22) Filed: Jul. 7, 2014

(30) Foreign Application Priority Data
Jul. 8, 2013 (JP) 2013-142908

(51) Int. Cl. G11B 5/65; H01F 1/03

(52) U.S. Cl. CPC G11B 5/653; H01F 1/0315
USPC 427/127; 423/594.2

(57) ABSTRACT

The method of manufacturing hexagonal ferrite magnetic particles comprises applying an adhering matter comprising a glass component and an alkaline earth metal to hexagonal ferrite magnetic particles, and subjecting the hexagonal ferrite magnetic particles to which the adhering matter has been applied to a heat treatment.

### CROSS-REFERENCE TO RELATED APPLICATIONS

This application claims the benefit of priority under 35 USC 119 to Japanese Patent Application No. 2013-142908 filed on Jul. 8, 2013, which is expressly incorporated herein by reference in its entirety.

### BACKGROUND OF THE INVENTION

1. Field of the Invention

The present invention relates to a method of manufacturing hexagonal ferrite magnetic particles. More particularly, the present invention relates to a method of manufacturing hexagonal ferrite magnetic particles that is capable of providing hexagonal ferrite magnetic particles having magnetic characteristics that are suited to a magnetic material for magnetic recording.

The present invention further relates to the hexagonal ferrite magnetic particles provided by the above manufacturing method, and to a magnetic recording medium comprising the hexagonal ferrite magnetic particles in a magnetic layer.

2. Discussion of the Background

Hexagonal ferrite is employed in permanent magnets, and in recent years, has been employed as a magnetic material in magnetic recording media.

The coprecipitation method (for example, Japanese Unexamined Patent Publication (KOKAI) No. 2010-001171), the hydrothermal synthesis method (for example, Japanese Unexamined Patent Publication (KOKAI) No. 2012-12253), and the glass crystallization method (for example, Japanese Unexamined Patent Publication (KOKAI) No. 2006-5299 and English language family member US2005/282043A1) are known methods of manufacturing hexagonal ferrite. The contents of the above publications are expressly incorporated herein by reference in their entirety.

### SUMMARY OF THE INVENTION

For example, the hexagonal ferrite magnetic particles that are employed as a magnetic material in magnetic recording are required to have high coercive force to achieve higher recording densities. However, hexagonal ferrite magnetic particles that are manufactured by the hydrothermal synthesis method, for example, tend to exhibit lower coercive force than such particles manufactured by other manufacturing methods. Accordingly, it is desirable to improve the magnetic characteristics so as to develop coercive force suited to magnetic recording applications. It is also desirable to improve the hexagonal ferrite magnetic particles obtained by other manufacturing methods and the hexagonal ferrite magnetic particles used for other applications so as to achieve magnetic characteristics that are suited to applications.

An aspect of the present invention provides for a means of providing hexagonal ferrite magnetic particles with improved magnetic characteristics.

The present inventors conducted extensive research for providing the above means, resulting in the following novel discovery.

The present inventors presumed that the reason for the low coercive force of the hexagonal ferrite magnetic particles obtained by the hydrothermal synthesis method was low particle crystallinity. Accordingly, they investigated the use of a heat treatment to heighten crystallinity. They found that a simple heat treatment would cause the particles to sinter and aggregate, making it difficult to obtain fine particles. However, higher recording densities are constantly being required of magnetic recording media. As a result, the size of the magnetic material shoukd be reduced.

In this regard, the present inventors investigated the use of glass components as sintering inhibitors to prevent the sintering of particles. As a result, a phenomenon came to light, namely, that of the crystal structure of the particles having changed to that of hematite following the heat treatment.

Accordingly, the present inventors conducted further extensive research into the above phenomenon As a result, they came to assume that the fact that the alkaline earth metal in the hexagonal ferrite was released to the exterior of the particle by the heat treatment was the reason the particles ended up being changed into hematite by the heat treatment. This point will be further described. Hexagonal ferrite contains an alkaline earth metal as a constituent element. However, alkaline earth metals tend to be picked up by glass. Accordingly, when hexagonal ferrite magnetic particles are subjected to a heat treatment when a glass component adheres to the hexagonal ferrite magnetic particles, the alkaline earth metal in the hexagonal ferrite is thought to end up being picked up by the glass.

Further research was conducted based on the above knowledge. As a result, the present inventors discovered that it was possible to improve the magnetic characteristics of hexagonal ferrite magnetic particles while inhibiting conversion into hematite by subjecting hexagonal ferrite magnetic particles to a heat treatment while an alkaline earth metal and a glass component adhere to the hexagonal ferrite magnetic particles. In this regard, the present inventors thought that the fact that the supplemental alkaline earth metal moved into the particles from an adhering matter containing both a glass component and an alkaline earth metal and the fact that the picking up of more alkaline earth metal by the adhering matter containing the glass component could be inhibited when the concentration of the alkaline earth metal in the adhering matter reached saturation contributed to inhibiting the conversion into hematite.

The present invention was devised on the basis of the above discovery.

An aspect of the present invention relates to a method of manufacturing hexagonal ferrite magnetic particles, which comprises:

applying an adhering matter comprising a glass component and an alkaline earth metal to hexagonal ferrite magnetic particles; and

subjecting the hexagonal ferrite magnetic particles to which the adhering matter has been applied to a heat treatment.

In an embodiment, the above method comprises causing the adhering matter to apply to the hexagonal ferrite magnetic particles by:

conducting a first adhering treatment in which hexagonal ferrite magnetic particles are subjected to adhering with a glass component; and

conducting a second adhering treatment in which the hexagonal ferrite magnetic particles after the first adhering treatment are subjected to adhering with an alkaline earth metal.

In an embodiment, the glass component is a hydrolysis product of a silicon compound.

In an embodiment, the silicon compound is alkoxysilane.

In an embodiment, the silicon compound is tetraethyl orthosilicate.

In an embodiment, the first adhering treatment is conducted by adding a precursor of the glass component to a solution comprising hexagonal ferrite magnetic particles and conducting stirring, to subject the hexagonal ferrite magnetic particles to adhering with the glass component in the form of a hydrolysis product of the precursor.

In an embodiment, the solution comprising hexagonal ferrite magnetic particles comprises a solvent, in the form of a mixed solvent of water and an organic solvent, and a surfactant.

In an embodiment, the surfactant is a quaternary ammonium base-containing compound.

In an embodiment, the surfactant is a salt of a quaternary ammonium cation and a halogen anion.

In an embodiment, the surfactant is cetyltrimethylammonium halide.

In an embodiment, the surfactant is cetyltrimethylammonium halide and the glass component is a hydrolysis product of tetraethyl orthosilicate.

In an embodiment, the second adhering treatment is a treatment by which hexagonal ferrite magnetic particles after the first adhering treatment are subjected to adhering with an alkaline earth metal salt by adding a precursor of an alkaline earth metal salt and an additional component for converting the precursor into an alkaline metal earth salt to a solution comprising hexagonal ferrite magnetic particles after the first adhering treatment and conducting stirring.

In an embodiment, a base is added in addition to the precursor of the alkaline earth metal salt and the additional component.

In an embodiment, the alkaline earth metal comprised in the adhering matter is the same kind of alkaline earth metal as that constituting the hexagonal ferrite magnetic particles.

In an embodiment, the alkaline earth metal is barium.

In an embodiment, the above method further comprises subjecting the hexagonal ferrite magnetic particles obtained following the heat treatment to a step of removing the adhering matter.

In an embodiment, the adhering matter is dissolved away by a base.

In an embodiment, the heat treatment is conducted at a temperature of 500° C. to 750° C.

In an embodiment, the above method provides hexagonal ferrite magnetic particles with higher coercive force than the hexagonal ferrite magnetic particles prior to applying the adhering matter.

A further aspect of the present invention relates to hexagonal ferrite magnetic particles provided by the above method.

In an embodiment, the hexagonal ferrite magnetic particles are employed as a magnetic material for magnetic recording.

In an embodiment, the hexagonal ferrite magnetic particles have a particle size ranging from 10 nm to 50 nm.

A further aspect of the present invention relates to a magnetic recording medium comprising a magnetic layer comprising ferromagnetic powder and binder, wherein the ferromagnetic powder is comprised of the above hexagonal ferrite magnetic particles.

An aspect of the present invention can provide hexagonal ferrite magnetic particles with improved magnetic characteristics. In an embodiment, hexagonal ferrite magnetic particles having coercive force suited to magnetic recording can be provided.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

The method of manufacturing hexagonal ferrite magnetic particles according to an aspect of the present invention comprises:

applying an adhering matter comprising a glass component and an alkaline earth metal to hexagonal ferrite magnetic particles; and

subjecting the hexagonal ferrite magnetic particles to which the adhering matter has been applied to a heat treatment.

As set forth above, the manufacturing method can improve the magnetic characteristics by means of the heat treatment as well as can prevent aggregation of the particles and their conversion into hematite in the heat treatment. Thus, hexagonal ferrite magnetic particles with good magnetic characteristics can be provided in the form of fine particles.

The manufacturing method will be described in greater detail below. In the present invention, the numbers preceding and succeeding the word “to” denote the minimum value and maximum value, respectively, of a range which includes these values.

### Hexagonal Ferrite Magnetic Particles

The hexagonal ferrite magnetic particles to which the adhering matter is applied (also referred to as the “starting material particles”, hereinafter) are not specifically limited. Both commercial products and products manufactured by known methods can be employed. As set forth above, the glass crystallization method, the hydrothermal synthesis method, the coprecipitation method, and the like are examples of methods of manufacturing hexagonal ferrite magnetic particles. More specifically, there is (1) the glass crystallization method comprising mixing into a desired ferrite composition alkaline earth metal oxide, iron oxide, and a metal oxide substituting for iron with a glass forming substance such as boron oxide; melting the mixture; rapidly cooling the mixture to obtain an amorphous material; reheating the amorphous material; and washing and pulverizing the product to obtain hexagonal ferrite crystal powder; (2) a hydrothermal synthesis method comprising neutralizing a ferrite composition metal salt solution with an alkali; removing the by-product; heating the liquid phase to equal to or greater than 100° C.; and washing, drying, and pulverizing the product to obtain hexagonal ferrite crystal powder; and (3) a coprecipitation method comprising neutralizing a ferrite composition metal salt solution with an alkali; removing the by-product; drying the product and processing it at equal to or less than 1,100° C.; and pulverizing the product to obtain hexagonal ferrite crystal powder. Any manufacturing method can be selected in the present invention.

In an embodiment, hexagonal ferrite magnetic particles manufactured by the hydrothermal synthesis method are desirably employed as the starting material particles. That is because fine particles can be readily obtained by the hydrothermal synthesis method and hexagonal ferrite magnetic particles that are suited to various applications such as magnetic recording medium for high-density recording can be obtained. However, the hexagonal ferrite magnetic particles obtained by the hydrothermal synthesis method tend to exhibit low coercive force, as set forth above. By contrast, the coercive force can be increased by subjecting the hexagonal ferrite magnetic particles to a heat treatment. This is thought to be due to heightened crystallinity of the hexagonal ferrite resulting from the heat treatment. However, the starting material particles are not limited to particles manufactured by the hydrothermal synthesis method; hexagonal ferrite magnetic particles obtained by various manufacturing methods can be employed.

The starting material particles are desirably equal to or less than 50 nm in particle size. Heat treating starting material particles with a particle size of equal to or less than 50 nm while inhibiting sintering can provide hexagonal ferrite magnetic particles in the form of fine particles with good magnetic characteristics. From the perspective of stable magnetization, a particle size of equal to or greater than 10 nm is desirable. From the perspective of increased recording density and stable magnetization, a particle size of equal to or greater than 20 nm and equal to or less than 50 nm is preferable, and equal to or greater than 20 nm and equal to or less than 40 nm is of greater preference.

The particle size in the present invention is a value that is measured by the following method.

An H-9000 model transmission electron microscope made by Hitachi is used to photograph the particles at a magnification of 100,000-fold and the photograph is printed on photographic paper at an overall magnification of 500,000-fold to obtain a particle photograph. Target magnetic particle is selected from the particle photograph, the contour of the particle is traced with a digitizer, and the particle size is measured with KS-400 Carl Zeiss image analyzing software. For multiple particles, the average value of the size of 500 particles is calculated as the average particle size.

In the present invention, the size of the particles constituting powder such as a magnetic particle (referred to as the “particle size”, hereinafter) is denoted as follows based on the shape of the particles observed in the above particle photograph:

(1) When acicular, spindle-shaped, or columnar (with the height being greater than the maximum diameter of the bottom surface) in shape, the particle size is denoted as the length of the major axis constituting the particle, that is, the major axis length.
(2) When platelike or columnar (with the thickness or height being smaller than the maximum diameter of the plate surface or bottom surface) in shape, the particle size is denoted as the maximum diameter of the plate surface or bottom surface.
(3) When spherical, polyhedral, of unspecific shape, or the like, and the major axis constituting the particle cannot be specified from the shape, the particle size is denoted as the diameter of an equivalent circle. The term “diameter of an equivalent circle” means that obtained by the circle projection method.

Further, the average particle size of the powder is the arithmetic average of the above particle size and is obtained by measuring 500 primary particles as set forth above. A “primary particle” refers to an individual, unaggregated particle of powder.

Reference can be made to Japanese Unexamined Patent Publication (KOKAI) No. 2011-216149, which is expressly incorporated herein by reference in its entirety, paragraphs 0134 to 0136, for example, for details regarding starting material particles in the form of hexagonal ferrite magnetic particles.

### Adhering Treatment with Adhering Matter

In the above manufacturing method, an adhering matter containing a glass component and an alkaline earth metal is applied to the starting material particles. In this manner, as set forth above, conversion into hematite and sintering of the particles can be inhibited during the subsequently conducted heat treatment.

The alkaline earth metal is desirably incorporated so that the concentration of the alkaline earth metal in the adhering matter reaches saturation, or near saturation, to inhibit the release of alkaline earth metal from the starting material particles. From this perspective, the concentration of the alkaline earth metal in the adhering matter is desirably equal to or greater than, preferably double or more, that of the alkaline earth metal in the starting material hexagonal ferrite. Additionally, it is considered possible to adequately inhibit the release of alkaline earth metal from the starting material particles with a concentration reaching saturation—even without employing an excess quantity of alkaline earth metal to form the adhering matter. From this perspective, the concentration of the alkaline earth metal concentration in the adhering matter is desirably five-fold or less, preferably three-fold or less.

It suffices for the adhering matter to contain a glass component and an alkaline earth metal, and the adhering matter can be applied by a dry method or a wet method. From the perspective of ease and uniformity in applying the adhering matter, adhering with a wet method is desirable and an adhering treatment conducted in solution is preferred.

The glass component and the alkaline earth metal can be caused to adhere to the starting material particles simultaneously or successively. Since alkaline earth metals tend to be readily picked up by glass as set forth above, from the perspective of the efficiency of adhering the alkaline earth metal, the alkaline earth metal is desirably caused to adhere (second adhering treatment) after adhering the glass component to the starting material particles (first adhering treatment).

The first adhering treatment and second adhering treatment will be described in order.

The first adhering treatment is a treatment by which the glass component is caused to adhere to the hexagonal ferrite magnetic particles. For the reasons set forth above, the first adhering treatment is desirably conducted by a wet method, and desirably conducted in a solution. For example, a glass component in the form of a hydrolysis product of a precursor can be caused to adhere to the particles by admixing the precursor of a glass component to a solution containing the starting material particles. In an embodiment, a precursor can be added to a solution containing the starting material particles, desirably in the form of a solution, in what is called the sol-gel method, to cause the glass component to deposit on the surface of the particles. An example of a precursor that is suitable for adhering a glass component to the particles is a silicon compound. Silane compounds such as alkoxysilanes are desirably employed as the silicon compound. Silica (SiO₂) can be caused to adhere to the particle surface by hydrolyzing a silane compound. Among these compounds, the use of tetraethyl orthosilicate (TEOS), which can form silica by the sol-gel method, is desirable. To promote hydrolysis of the glass component precursor, a base can be added as needed in addition to the glass component precursor. Examples of bases are sodium hydroxide, potassium hydroxide, sodium carbonate, and ammonia water. Since basic conditions can be achieved with just a small quantity, the use of sodium hydroxide is desirable. From the perspective of little dissolution of the glass component that adheres to the particles, the use of a weak base in the form of ammonia water is desirable. The quantity of base employed is not specifically limited.

The first adhering treatment is desirably conducted with starting material particles that have been subjected to a surface-modifying treatment with a surfactant to obtain fine hexagonal ferrite magnetic particles. A solution containing starting material particles that have been subjected to the surface-modifying treatment with a surfactant and a solution containing the glass component precursor are preferably mixed and stirred. Since this makes it possible to hydrolyze and cause to adhere the glass component precursor to the surface of starting material particles dispersed to a high degree due to the effect of the surfactant, it becomes possible to cause to adhere the glass component (hydrolysis product) to fine particles. The quantity of glass component precursor that is added to the solution can be, for example, a quantity falling within a range of 0.05 mole percent to 2.0 mole percent, desirably a quantity falling within a range of 0.05 mole percent to 0.4 mole percent, per 1 mole of iron constituting the starting material particles.

For example, the surface-modifying treatment of the starting material particles with a surfactant can be conducted by admixing the surfactant and an optional organic solvent to a solution containing the starting material particles and water. Within the solution thus prepared, the dispersion of the starting material particles can be increased by adsorption of the surfactant to the surface of the starting material particles. For example, when the hydrophobic group of the surfactant functions as a functional group adsorbing to the starting material particles, the surface of the starting material particles will be surrounded by the hydrophilic group of the surfactant. Thus, from the perspective of dispersion of the particles, this solution is desirably one in which the principal solvent is water. Conversely, when the hydrophilic group of the surfactant functions as a functional group adsorbing to the starting material particles, the surface of the starting material particles will be surrounded by the hydrophobic group of the surfactant. Thus, from the perspective of dispersion of the particles, this solution is desirably one in which the principal solvent is an organic solvent. In the present invention, the term “principal solvent” means a solvent accounting for equal to or greater than 50 weight percent, desirably equal to or greater than 70 weight percent, and preferably, equal to or greater than 90 weight percent, of the total solvent contained in the solution.

From the perspective of further enhancing dispersion, a surface-modifying treatment with a dispersing agent or dispersing adjuvant is desirable. Examples of compounds that are suitable as dispersing agents or dispersing adjuvants are linear unsaturated fatty acids with 3 to 17 carbon atoms, such as oleic acid, and linear unsaturated aliphatic amines with 16 to 18 carbon atoms, such as oleylamines. The quantity of these compounds that are added is not specifically limited and can be suitably adjusted.

The organic solvent can be employed in the form of any ratio of ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorhydrin, and dichlorobenzene; N,N-dimethylformamide; and hexane.

A cationic surfactant, anionic surfactant, nonionic surfactant, or amphoteric surfactant can be employed as the surfactant. A cationic surfactant is an example of a desirable surfactant, and a quaternary ammonium base-containing compound (quaternary ammonium salt surfactant) is preferred.

Examples of quaternary ammonium salt surfactants are the compounds denoted by the general formula given below. The R in the quaternary ammonium cation denoted by —N⁺R₃ is, for example, an alkyl group having 1 to 5 carbon atoms, desirably a linear alkyl group having 1 to 3 carbon atoms. The three instances of R can each be different, any two can be identical, or all three can be identical.

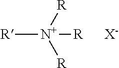

The anion X⁻ forming a salt with the ammonium cation is not specifically limited. From the perspective of availability, halogen anions such as Cl⁻ and Br⁻ are suitable.

From the perspective of obtaining fine hexagonal ferrite magnetic particles, the quaternary ammonium salt surfactant above is desirably an aliphatic compound in which R′ in the above general formula denotes an aliphatic group. The aliphatic group denoted by R′ is desirably a linear or branched alkyl group. The number of carbon atoms in the aliphatic group is suitably about 10 to 20. The aliphatic group can also optionally contain substituents such as halogen atoms and the like. When the aliphatic group denoted by R′ contains a substituent, the number of carbon atoms in the substituent refers to the number of carbon atoms of the portion excluding the substituent. From the perspectives of availability and particle size reduction, cetyltrimethylammonium bromide (CTAB) is preferred. The quantity of surfactant employed can be suitably adjusted based on the quantity of starting material particles in the solution and the size of the starting material particles so that the surface of the starting material particles is adequately covered.

Following the first adhering treatment, the particles can be subjected to steps such as washing and drying. Alternatively, they can be subjected to the second adhering treatment as is.

The second adhering treatment is a treatment in which an alkaline earth metal is caused to adhere to the hexagonal ferrite magnetic particles following the first adhering treatment. The second adhering treatment can also be conducted by a dry method or a wet method. For the same reasons as for the first adhering treatment, it is desirably conducted by a wet method, preferably in a solution.

The second adhering treatment in a solution can be conducted by adding an alkaline earth metal salt to a solution containing the hexagonal ferrite magnetic particles that have been subjected to the first adhering treatment, and causing to adhere to the surface of the particles. It can also be conducted by admixing a precursor of an alkaline earth metal salt and an additional component for converting the precursor into an alkaline earth metal salt to the solution. In the latter method, the precursor of the alkaline earth metal salt can be converted into the alkaline earth metal salt by a reaction such as salt formation, neutralization, or hydrolysis and caused to adhere to the surface of the particles. The solution containing hexagonal ferrite magnetic particles that have been subjected to the first adhering treatment desirably refers to a solution in which the hexagonal ferrite magnetic particles that have been subjected to the first adhering treatment have been dispersed. The use of a surfactant is also desirable from the perspective of obtaining such as solution, as set forth above.

In the latter method, for example, the precursor of an alkaline earth metal salt and an additional component for converting the precursor into the alkaline earth metal salt can be admixed to the solution and stirring can be conducted to cause the alkaline earth metal salt to adhere to the hexagonal ferrite magnetic particles to which a glass component adheres in the solution. Examples of the additional component are salts containing anionic components capable of forming alkaline earth metal salts of lower solubility in the solution than the anionic component that is contained in the precursor by forming salts with alkaline earth metal cations. For example, when conducting the alkaline earth metal salt adhering treatment in an aqueous solution or in a water-based solution containing water as the principal solvent, a water-soluble salt such as an alkaline earth metal nitrate or chloride can be employed as the precursor and an alkaline metal carbonate can be employed as the additional component to cause an alkaline earth metal carbonate to adhere to the surface of the particles. The above reaction is desirably conducted under basic conditions from the perspective of achieving smooth conversion of the precursor into the alkaline earth metal salt. Examples of the base that is added to the solution to render it basic are sodium hydroxide, potassium hydroxide, sodium carbonate, and ammonia water. From the perspective of achieving basic conditions with just a small quantity, the use of sodium hydroxide is desirable. From the perspective of little dissolution of the glass component that adheres to the particles, the use of a weak base in the form of ammonia water is suitable. Further, by bubbling carbon dioxide through the solution after converting the precursor of the alkaline earth metal salt into an alkali such as a hydroxide in the basic solution, it is possible to cause alkaline earth metal carbonate to precipitate and adhere to the particles.

Unsubstituted hexagonal ferrite is a metal oxide denoted by AFe₁₂O₁₉. In the formula, A denotes an alkaline earth metal such as barium, strontium, calcium, or lead. There are some hexagonal ferrites in which a portion of the metal element is replaced with a substitute element such as Co, Al, Ti, or Zn. For example, hexagonal ferrite in which A denotes barium is barium ferrite.

As set forth above, in hexagonal ferrite to which just a glass component adheres and then heat treated, the fact that the alkaline earth metal that is denoted by A may end up being picked up by the glass is thought to result in conversion into hematite. By contrast, the present inventors surmise that adhering with both a glass component and an alkaline earth metal in the above manufacturing method can prevent the alkaline earth metal constituting the hexagonal ferrite from being released to the exterior of the particle, making it possible to inhibit conversion into hematite. From the perspective of effectively inhibiting conversion into hematite, an alkaline earth metal of the same kind as the alkaline earth metal constituting the hexagonal ferrite is desirably caused to adhere to the starting material particles.

### Heat Treatment

In the hexagonal ferrite magnetic particles to which an adhering matter containing a glass component and an alkaline earth metal adheres as set forth above, the entire surface can be covered with the adhering matter, or the adhering matter can be applied as a discontinuous phase in the form of “islands in the sea.” The hexagonal ferrite magnetic particles to which the adhering matter has been applied can be processed as needed to remove them from the solution; washed, dried, pulverized, and the like; and then subjected to a heat treatment. Pulverizing makes it possible to conduct uniform heating and can facilitate the removal of the adhering matter following the heat treatment.

The heat treatment can be conducted, for example, at a heating temperature of 400° C. to 800° C., desirably 500° C. to 750° C. In this context, the heating temperature refers to the temperature of the atmosphere in which the heat treatment is conducted. The atmosphere in which the heat treatment is conducted is not specifically limited. It can be conducted in an oxygen-containing atmosphere such as air, or in an inert atmosphere. The duration of the heat treatment can be, for example, from about 1 minute to about 1 hour, but is not specifically limited and can be suitably set. When the heat treatment is conducted without the adhering matter, sintering of the particles ends up causing the formation of coarse particles. The adhering of just a glass component ends up causing the hexagonal ferrite to convert into hematite. By contrast, by applying an adhering matter containing a glass component and an alkaline earth metal, followed by subjecting the hexagonal ferrite magnetic particles to a heat treatment in the above manufacturing method, the heat treatment can inhibit both sintering and conversion into hematite by the particles. The heat treatment can also enhance the magnetic characteristics of the hexagonal ferrite magnetic particles.

The adhering matter may remain on the surface of the particles following the heat treatment. The adhering matter can be removed or left in place. It is desirable to remove the adhering matter to enhance the magnetic characteristics of the magnetic particles. The adhering matter can be dissolved away, for example, by the method of immersing the particles in a basic solution such as sodium hydroxide (alkali washing), or with hydrofluoric acid (HF). The alkali washing is desirably employed due to the difficulty of handling hydrofluoric acid.

In the method of manufacturing hexagonal ferrite magnetic particles that is described above, aggregation of particles due to sintering during the heat treatment can be prevented. Thus, it is possible to obtain fine hexagonal ferrite magnetic particles. For example, the above manufacturing method can yield fine hexagonal ferrite magnetic particles that are suitable as a magnetic material in magnetic recording medium for high-density recording and that have a particle size ranging from 10 nm to 50 nm.

The above manufacturing method can yield hexagonal ferrite magnetic particles with improved magnetic characteristics from starting material particles. For example, it is desirable to increase the coercive force of the magnetic material for magnetic recording to achieve higher density recording. In this regard, the above manufacturing method can yield hexagonal ferrite magnetic particles of greater coercive force than the hexagonal ferrite magnetic particles (starting material particles) prior to the first adhering treatment. From the perspective of achieving higher density recording, the coercive force of the hexagonal ferrite magnetic particles is desirably 143.3 kA/m to 318.5 kA/m (1,800 Oe to 4,000 Oe), preferably 159.2 kA/m to 238.9 kA/m (2,000 Oe to 3,000 Oe), and more preferably, 191.0 kA/m to 214.9 kA/m (2,200 Oe to 2,800 Oe). When the coercive force of the starting material particles does not fall within the above desirable range, the coercive force can be raised to within the desired range by the heat treatment. From the perspective of raising the coercive force, the above heat treatment is desirably conducted at a temperature that is higher than the temperature of the heat treatment conducted in the manufacturing process.

A further aspect of the present invention can provide the hexagonal ferrite magnetic particles provided by the above-described manufacturing method.

The above hexagonal ferrite magnetic particles are obtained by the above manufacturing method. Thus, for example, they can be fine particles with a particle size falling within a range of 10 nm to 50 nm. Such a fine magnetic material is suitable as a magnetic material for magnetic recording. Since the heat treatment is conducted while inhibiting particle sintering and conversion into hematite, the fact that good magnetic characteristics can be achieved can also ensure suitability as a magnetic material for magnetic recording.

The above hexagonal ferrite magnetic particles can be mixed with binder and solvent to prepare a coating liquid and the coating liquid can be coated on a support to form a magnetic layer. Accordingly, the above hexagonal ferrite magnetic particles are suitable for use in particulate magnetic recording media.

That is, a further aspect of the present invention can yield a magnetic recording medium, comprising a magnetic layer comprising ferromagnetic powder and binder on a nonmagnetic support, in which the above hexagonal ferrite magnetic particles are the above ferromagnetic powder. The magnetic recording medium can have a multilayered structure sequentially comprising, on a nonmagnetic support, a nonmagnetic layer comprising nonmagnetic powder and binder, and a magnetic layer comprising the above hexagonal ferrite magnetic particles and binder. A backcoat layer can be present on the opposite surface of the nonmagnetic support of the magnetic recording medium from the surface on which the magnetic layer is present. Known techniques relating to magnetic recording media can be applied to the manufacturing of the magnetic recording medium employing the above hexagonal ferrite magnetic particles.

### EXAMPLES

The present invention will be described in detail below based on Examples. However, the present invention is not limited to Examples. The term “percent” given in Examples is weight percent and the ratio given in Examples is a weight ratio.

### Example 1

[Procedure 1: Treatment with Dispersing Adjuvant]

Water was added to 5 g of barium ferrite (denoted as “BaFe”, hereinafter) particles to wet the entire quantity. Subsequently, 0.2 mL of oleylamine and 0.2 mL of oleic acid were added and the mixture was mixed while being kneaded in a mortar. Subsequently, the mixture was transferred to a Teflon (registered trademark) flask. The kneaded product adhering to the mortar was transferred to the Teflon flask while being diluted with water.

The quantity of water employed in procedure 1 was 105 g.

[Procedure 2: Surface-Modifying Treatment with Surfactant]

To the BaFe-containing aqueous solution prepared in procedure 1 was added 1.5 g of surfactant in the form of cetyltrimethylammonium bromide (CTAB). After adding 15 g of chloroform, the mixture was stirred for a day and a night with a stirring blade.

### [Procedure 3: First Adhering Treatment (Glass Component Adhering Treatment)]

To the solution prepared in procedure 2 was added 1.5 mL of 2.5 percent ammonia water. One gram of tetraethyl orthosilicate (TEOS) diluted to 1 percent % with butanol was added and the mixture was again stirred for a day and a night. This hydrolyzed the TEOS and silica adhered to the surface of the BaFe particles.

### [Procedure 4: Second Adhering Treatment (Alkaline Earth Metal Salt Adhering Treatment)]

The solution obtained in procedure 3 was centrifuged and the supernatant was discarded. The mixture was redispersed in 112 g of water. A 0.67 mL quantity of 25 percent ammonia water was added to 14.6 g of a 5 percent aqueous solution of barium nitrate, the mixture was stirred, and the redispersion was added thereto.

Subsequently, 53.4 g of a 5 percent aqueous solution of sodium carbonate was added and the mixture was stirred for a day and a night.

This yielded particles in which silica and barium carbonate adhered to the surface of BaFe particle.

### [Procedure 5: Heat Treatment]

The solution obtained in procedure 4 was centrifuged and the precipitate was recovered, dried, and somewhat pulverized in a mortar. The powder thus obtained was heat treated for 5 minutes at a heating temperature of 700° C. while delivering 1 L/min of air in an imaging furnace made by ULVAC-Riko. The starting material BaFe particles were manufactured by the hydrothermal synthesis method. The maximum temperature in the heat treatment conducted during manufacturing was about 500° C.

### [Procedure 6: Removing the Adhering Matter]

The heat-treated powder obtained in procedure 4 was irradiated with ultrasound at 60° C. for two hours in a 5N NaOH aqueous solution. It was subsequently maintained for 1 hour at 80° C. and left standing for a day and a night in a location at room temperature to remove the adhering matter from the particle surface. Next, the product was centrifuged and the precipitate was recovered. The precipitate was redispersed in pure water, washed by centrifugation, and subsequently air dried.

### Comparative Example 1

With the exception that the adhering treatment with an alkaline earth metal salt of procedure 4 was not conducted, the same processing was conducted as in Example 1.

Evaluation Methods

### (1) X-ray Diffraction Analysis

The BaFe powders obtained in Example 1 and Comparative Example 1 and the starting material BaFe powder were analyzed by powder X-ray diffraction with an X'Pert PRO (CuKα radiation source, 45 kV voltage, 40 mA current) made by PANalytical Corp.

In the powder obtained in Example 1 and the starting material BaFe powder, hexagonal ferrite (barium ferrite) was detected as the main component by X-ray diffraction analysis. The phrase “hexagonal ferrite was detected as the main component” means that the peak exhibiting the maximum intensity in the X-ray diffraction spectrum was derived from the crystal structure of hexagonal ferrite.

By contrast, in the powder obtained in Comparative Example 1, a peak derived from hematite was detected along with the peak derived from the crystal structure of barium ferrite in X-ray diffraction analysis, and the peak exhibiting the maximum intensity was that derived from hematite.

### (2) Magnetic Characteristics

The coercive force He of the powders obtained in Example 1 and Comparative Example 1, and that of the starting material BaFe powder, were measured with a Vibrating Superconducting Magnetometer (VSM) (3T external magnetic field) made by Tamakawa Co., Ltd.

### (3) Measurement of Particle Size

The average particle size (average plate diameter) of the powders obtained in Example 1 and Comparative Example 1, and that of the starting material BaFe powder, were measured by the method set forth above by a transmission electron microscope.

TABLE 1

| | | | | | Main component | Average |
|---|---|---|---|---|---|---|
| | First | Second | | | detected by X- | plate |
| | adhering | adhering | Heat | | ray diffraction | diameter |
| | treatment | treatment | treatment | Hc | analysis | (nm) |
| Ex. 1 | Conducted | Conducted | Conducted | 181 kA/m | BaFe | 30 |
| | | | | (2270 Oe) | | |
| Comp. | Conducted | Not | Conducted | 79.6 kA/m | Hematite | 30 |
| Ex. 1 | | Conducted | | (1000 Oe) | | |
| Starting | Not | Not | Not | 159 kA/m | BaFe | 30 |
| material | Conducted | Conducted | Conducted | (2000 Oe) | | |
| BaFe powder | | | | | | |

Evaluation Results

Comparative Example 1 was an example in which the heat treatment was conducted without adhering of barium carbonate after adhering of silica. As shown in Table 1, the main component detected by X-ray diffraction was hematite. The reason for the drop in coercive force relative to the starting material BaFe in Comparative Example 1 was thought to be the conversion into hematite.

By contrast, as shown in Table 1, barium ferrite magnetic particles with greater coercive force than the starting material BaFe were obtained in Example 1. This was thought to have occurred because the heat treatment was conducted after applying an adhering matter of silica and barium carbonate, inhibiting the picking up of barium in the barium ferrite by the silica.

Further, based on the results given in Table 1, conducting the heat treatment after the above adhering treatments was found to prevent sintering of the particles during the heat treatment.

The above results indicate that an aspect of the present invention can provide hexagonal ferrite magnetic particles in the form of fine particles with good magnetic characteristics.

It is possible to provide a magnetic recording medium for use in high-density recording that can exhibit good electromagnetic characteristics by using the hexagonal ferrite magnetic particles thus obtained as ferromagnetic powder in the magnetic layer.

An aspect of the present invention is useful in the field of manufacturing magnetic recording media.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A method of manufacturing hexagonal ferrite magnetic particles, which comprises:
applying an adhering matter comprising a glass component and an alkaline earth metal to hexagonal ferrite magnetic particles; and
subjecting the hexagonal ferrite magnetic particles to which the adhering matter has been applied to a heat treatment.

2. The method of manufacturing hexagonal ferrite magnetic particles according to claim 1, which comprises causing the adhering matter to apply to the hexagonal ferrite magnetic particles by:
conducting a first adhering treatment in which hexagonal ferrite magnetic particles are subjected to adhering with a glass component; and
conducting a second adhering treatment in which the hexagonal ferrite magnetic particles after the first adhering treatment are subjected to adhering with an alkaline earth metal.

3. The method of manufacturing hexagonal ferrite magnetic particles according to claim 1, wherein the glass component is a hydrolysis product of a silicon compound.

4. The method of manufacturing hexagonal ferrite magnetic particles according to claim 3, wherein the silicon compound is alkoxysilane.

5. The method of manufacturing hexagonal ferrite magnetic particles according to claim 3, wherein the silicon compound is tetraethyl orthosilicate.

6. The method of manufacturing hexagonal ferrite magnetic particles according to claim 2, wherein the first adhering treatment is conducted by adding a precursor of the glass component to a solution comprising hexagonal ferrite magnetic particles and conducting stirring, to subject the hexagonal ferrite magnetic particles to adhering with the glass component in the form of a hydrolysis product of the precursor.

7. The method of manufacturing hexagonal ferrite magnetic particles according to claim 6, wherein the solution comprising hexagonal ferrite magnetic particles comprises a solvent, in the form of a mixed solvent of water and an organic solvent, and a surfactant.

8. The method of manufacturing hexagonal ferrite magnetic particles according to claim 7, wherein the surfactant is a quaternary ammonium base-containing compound.

9. The method of manufacturing hexagonal ferrite magnetic particles according to claim 7, wherein the surfactant is a salt of a quaternary ammonium cation and a halogen anion.

10. The method of manufacturing hexagonal ferrite magnetic particles according to claim 7, wherein the surfactant is cetyltrimethylammonium halide.

11. The method of manufacturing hexagonal ferrite magnetic particles according to claim 7, wherein the surfactant is cetyltrimethylammonium halide and the glass component is a hydrolysis product of tetraethyl orthosilicate.

12. The method of manufacturing hexagonal ferrite magnetic particles according to claim 2, wherein the second adhering treatment is a treatment by which hexagonal ferrite magnetic particles after the first adhering treatment are subjected to adhering with an alkaline earth metal salt by adding a precursor of an alkaline earth metal salt and an additional component for converting the precursor into an alkaline metal earth salt to a solution comprising hexagonal ferrite magnetic particles after the first adhering treatment and conducting stirring.

13. The method of manufacturing hexagonal ferrite magnetic particles according to claim 12, wherein a base is added in addition to the precursor of the alkaline earth metal salt and the additional component.

14. The method of manufacturing hexagonal ferrite magnetic particles according to claim 1, wherein the alkaline earth metal comprised in the adhering matter is the same kind of alkaline earth metal as that constituting the hexagonal ferrite magnetic particles.

15. The method of manufacturing hexagonal ferrite magnetic particles according to claim 1, wherein the alkaline earth metal is barium.

16. The method of manufacturing hexagonal ferrite magnetic particles according to claim 1, which further comprises subjecting the hexagonal ferrite magnetic particles obtained following the heat treatment to a step of removing the adhering matter.

17. The method of manufacturing hexagonal ferrite magnetic particles according to claim 16, wherein the adhering matter is dissolved away by a base.

18. The method of manufacturing hexagonal ferrite magnetic particles according to claim 1, wherein the heat treatment is conducted at a temperature of 500° C. to 750° C.

19. The method of manufacturing hexagonal ferrite magnetic particles according to claim 1, which provides hexagonal ferrite magnetic particles with higher coercive force than the hexagonal ferrite magnetic particles prior to applying the adhering matter.
